(19) United States
(12) Patent Application Publication
(10) Pub. No.: US 2008/0319801 A1
(43) Pub. Date: Dec. 25, 2008

(54) Warranted Retail Transaction

(76) Inventor: Jeffrey R. Wilson, Alpharetta, GA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/753,881

(22) Filed: May 25, 2007

Related U.S. Application Data
(60) Provisional application No. 60/888,117, filed on Feb. 5, 2007.
(60) Provisional application No. 60/803,389, filed on May 30, 2006.
(60) Provisional application No. 60/803,360, filed on May 27, 2006.

(51) Int. Cl. G06Q 40/00; G06Q 30/00

(52) U.S. Cl. 705/4

(57) ABSTRACT

A method of providing a warranty coupled with an identity verification system having the steps of verifying the identity of a party, and, if the identity is fraudulent despite the verification, reimbursing the user of the identity verification system for losses due to the fraud. The warranty may also cover other costs and fees associated with the fraud. The warranty may be provided as part of an identity verification system, or identity verification may be a prerequisite for coverage under the warranty. The warranty may be insured to help distribute costs. There may be exceptions, limitations, and deductibles associated with coverage under the warranty.

### CROSS-REFERENCE TO RELATED APPLICATIONS

This application claims priority to U.S. Provisional Application No. 60/888,117, filed on Feb. 5, 2007, U.S. Provisional Application No. 60/803,389, filed on May 30, 2006, and U.S. Provisional Application No. 60/803,360, filed on May 27, 2006, which are hereby incorporated by reference.

### FIELD OF THE INVENTION

This invention relates in general to financial transaction security and in particular to a method for warranting an identity verification process used by a party to a financial transaction. This invention more particularly relates to providing a warranty to a party to cover their liability in the event that the identity verification method used by the party did not prevent the completion of a fraudulent transaction.

### BACKGROUND OF THE INVENTION

With the advent of the World Wide Web, and the increased use of the Internet for shopping and other financial transactions, one's personal and identification information is more readily available to others than ever before. More traditional ways of obtaining identity information are also still in use by criminals intent on fraud. Regardless of how identity information is obtained by a criminal, once it is used for fraud, there is a significant cost to both the person whose identity information was stolen, and the businesses and institutions who were on the other side of the fraudulent transaction. Therefore, financial institutions, merchants and consumers are always searching for better ways to protect themselves from identity fraud losses.

There are many methods currently used to prevent identity fraud. Typically, these methods focus on three aspects of identity verification. The first is verification that the identity documents presented by a party are legitimate. This usually involves checking a database or other authoritative source to confirm that a document presented is authentic. For instance, a bank may check a state's Department of Motor Vehicles database to confirm that a driver's license presented during a transaction is authentic and unexpired. The second aspect of verification focuses on verifying that the person represented by the identity information or document is an actual person. For example, a merchant may verify that the name, address, and phone number presented on a credit application actually exist and are related to one another. A third aspect of identity verification involves verifying that the person presenting identity information is actually the person whose identity is represented by the information. There are many ways to do this, including questioning the potential customer on their alleged background using historical and background information derived from a variety of sources, and employing biometric verification (for example, matching a person's fingerprint with a fingerprint contained on a credit card or driver's license.) “Out of band” methods are also used, such as when an identity verification service generates a random number and calls the mobile phone associated with a credit card to provide the number to the owner of the card, who then provides it to the merchant to verify that the card owner is the person attempting to use the card.

While verifying an identity using any of the variety of methods and systems available is a good way to prevent identity fraud and may stop the bulk of fraudulent activities, no identity verification system is going to catch every false identity. As long as determined criminals are intent on fraudulently using identities to acquire goods and services, there will be some successful identity fraud transactions. Therefore, there is a need in the art for a way to protect the victims of such fraud by minimizing their losses from identity fraud.

### SUMMARY OF THE INVENTION

The present invention is generally directed to a method of warranting an identity verification system used in a financial transaction. An identity verification system is employed by one party when two parties begin a financial transaction. The system employed may be any of those currently available or yet to be developed. The identity verification system is coupled with a warranty which protects the user of the method in the event that a party fraudulently representing their identity is able to successfully verify a false identity despite not being the person claimed. The warranty provides for reimbursement of losses due to fraudulence in the transaction and may also provide reimbursement of related expenses. The warranty may be combined with insurance, to further mitigate losses and lessen the costs of maintaining the warranty. Other aspects of the present invention are described below.

### BRIEF DESCRIPTION OF THE DRAWINGS

The foregoing summary as well as the following detailed description of the invention are better understood when read in conjunction with the appended drawing. In the drawing:

FIG. 1 is a flow diagram of an example method of verifying a party's identity and utilizing a warranty in the event that the verification was incorrect.

### DETAILED DESCRIPTION OF THE INVENTION

The following provides a detailed description of the present invention in accordance with preferred embodiments. As the present invention allows for the customization of various aspects of the invention to meet specific user needs, the following description is intended as a generic representation based on needs identified as common among parties to financial transactions. Specific examples are used for illustrative purposes only and are not intended to limit the scope or subject matter disclosed herein. It is contemplated that parts or all of this invention may be automated, by computer or otherwise, for ease of use and implementation.

The present invention is a method of warranting an identity verification system used in a financial transaction. The typical financial transaction will involve at least two parties. The first party is typically a merchant, bank, or financial institution, but may also be an individual or any other entity that may be involved in a financial transaction, such as an insurer. The second party is typically a consumer, but may also be another merchant, bank, financial institution, or any other entity that may be involved in a financial transaction. For the purposes of this description, the “subscriber” is the first party requesting identification information and utilizing the method disclosed herein, and the “consumer party” is the second party that is providing the identification information. The term “subscriber”, however, should not be considered limiting because the service may be provided by either a third party or implemented in-house by the subscriber itself. The subscriber will use the identity information to verify the identity of the consumer party, and make claims against the warranty should a fraudulent transaction succeed despite using the identity verification system. For illustrative purposes, the example of a person purchasing a car from a car dealer will be used throughout this document. In that example, the car purchaser is the “consumer party”, and the car dealer is the “subscriber” of the service embodying the present invention.

Typical transactions that would benefit from the use of the present invention include the any transaction involving the sale of good or services. Examples of such transactions include, but are not limited to, purchasing a car, real estate, or other high value item, securing a loan or other line of credit, applying for membership in an association or club, applying to rent an apartment or house, and accessing existing financial or other kinds of accounts. The present invention will be beneficial to any transaction involving at least two parties where the identity of at least one of the parties is verified using an identity verification system. Other embodiments and uses of the present invention that adhere to the spirit and scope of this disclosure but are not explicitly disclosed herein are contemplated as uses of the present invention.

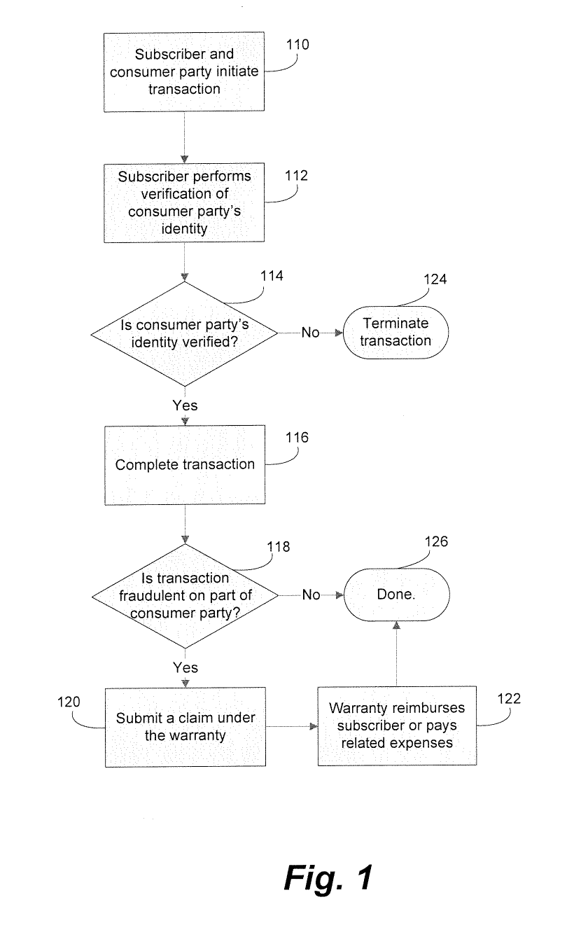

FIG. 1 illustrates the method of providing a warranty to protect the subscriber of an identity verification system in the event that the consumer party is fraudulently presenting identity information and it is not detected by the verification method. In step 110, the subscriber and the consumer party enter into a proposed transaction. This can be any kind of transaction where it is important to verify of the identity of the consumer party, as described above. Next, in step 112, the subscriber performs verification of the consumer party's identity by employing an identity verification system. There are many possible identity verification systems available for subscribers.

One exemplary identity verification system involves questioning a consumer party on the historical and background information associated with the identity presented to determine if the party is in fact the same person as that represented in the identity. The first step of this verification system is to gather initial identity information from the consumer party whose identity is to be verified. This information may be contained in a document, such as a driver's license or passport. It may also be provided directly by the consumer party, for example orally in person or over the phone, electronically over the Internet, or via any other means of communication. Examples of such initial identity information include social security number, driver's license number and name and address. Using the car purchase example, the purchaser is the consumer party and may fill out an application for a car loan in the financing department of the car dealer. The application will typically require at least basic identification information such as name, address, phone number, etc. Next, background and historical data on the consumer party is gathered based on the identity information provided. This data may be collected electronically by querying databases containing historical records and background information. Data collected may include, but is not limited to, educational records, marital records, employment records, residence history, credit history, job history, names of family members, social and civic affiliations, and financial information. At least one question (typically several) is then developed based on the data gathered. Using the car purchase example, a set of multiple choice questions may be generated which would likely provide effective probing of the purchaser's knowledge of the identity presented, yet not be too time-consuming to read and answer.

Next, in this exemplary identity verification system, the questions generated are presented to the consumer party whose identity is being verified, and the consumer party provides answers to the questions. The answers are collected and compared to the background and historical data, and the number or percentage of correct answers is determined. Then, a determination is made on whether a sufficient number of correct answers have been delivered by the consumer party to consider the party's identity successfully verified. The number or percentage of correct answers required to consider an identity verified may vary depending on the system and the needs of the subscriber. In a high value transaction, or one involving only a few questions that are based on relatively basic background information, it may be desirable to require all answers to be correct before considering the identity verified. In this example identity verification system, if the consumer party answers all or a sufficient number of the questions correctly, it is presumed that the consumer party and the person described in the identity information are the same and the identity is not fraudulent. If the consumer party fails to answer a sufficient number of the questions correctly, the consumer party may not be the person they are claiming to be and the transaction may be denied in the discretion of the subscriber.

Another exemplary identity verification system involves the use of biometric authentication. For example, when a consumer party obtains a new credit card, they may be asked to submit a finger print sample, which is kept on file by the credit card company. When the credit card is used, the subscriber would obtain a fingerprint from the consumer party presenting the credit card, and a check would be performed to see if it matches the print on file. If the prints match, it would be presumed that the consumer party is the true holder of the credit card, and the transaction would proceed. This system may be employed even if the credit card is not the means of payment for the goods or services involved in the transaction, but is used only to verify that the person named on the credit card is the same person presenting it. Also, biometric verification may be used with other forms of payment or identification, such as a driver's license or a debit card. Other forms of biometric authentication may include the use of retinal scanning, handprints matching, and voice identification. Almost any unique biometric identifier may be used in a biometric identity verification technique.

Yet another exemplary identity verification system is the “out of band” verification system. This system may be implemented in a variety of ways, but typically involves the use of a personal identification number (PIN) and a phone associated with a credit cardholder (typically a mobile phone.) In one implementation, when a purchase is attempted and identity verification is requested by the merchant, the phone is called and a random PIN is provided to the person answering, presumably the owner of the credit card. Alternatively, the random PIN may be emailed or sent as a text message to the phone associated with card owner. If the card owner is the person attempting to use the card, they will provide the random PIN to the merchant, who verifies with the credit card company that the PIN provided by the customer matches that provided to the owner of the card. In another implementation of an “out of band” system, the card owner has a permanent PIN associated with their credit card, as well as a phone number. When a purchase is attempted, the phone number is called and the PIN is requested. Alternatively, the PIN my be requested via email or text message. If the person answering the phone enters the correct PIN, the purchase is allowed to go forward.

Another example of an identity verification system involves the use of radio-frequency identification (RFID) or a similar proximity detection mechanism. In this system, the credit card would contain an RFID tag that corresponds to an RFID receiver in the card owner's possession. The RFID receiver may be located in a device separate from the credit card that the card owner would normally carry, such as a mobile phone. If the credit card is not in communication with the receiver, it will not activate or otherwise function properly for a purchase. Therefore, if the card is stolen, it will presumably be too far from its rightful owner to maintain communication with its corresponding RFID tag, and therefore be rendered useless to a thief. A similar system may utilize a signal (radio, Bluetooth, infrared, etc.) which is transmitted from the card owner's mobile phone to a merchant device to verify that the card owner is the person presenting the credit card.

Yet another example of an identity verification system focuses on verifying the authenticity of identification documents. When such documents are presented to a merchant, they are analyzed to compare their composition and appearance to examples of authentic documents to determine if they are legitimate. The documents used for comparison may be actual identification documents, or templates of authentic documents. The documents may be physically compared, or the comparison may be performed with an optical or electronic system.

While several examples of identity verification systems have been described herein, they are not intended to be limiting examples, and other identity verification systems, either currently in existence or yet to be developed, that adhere to the spirit and scope of this disclosure but are not explicitly disclosed herein are contemplated as part of the present invention.

In step 114, the results of the identity verification are evaluated. If the consumer party's identity is not verified, then the subscriber terminates the transaction in step 124. If the consumer party's identity is verified, the subscriber and the consumer party complete the transaction in step 116. In the car purchase example, after the purchaser's identity has been verified, the car is turned over to the purchaser after the remaining paperwork is completed.

The next step 118, where the subscriber determines whether the transaction was fraudulent or not, may take place some length of time after the previous step 116. This is because the subscriber will not likely find out that the transaction was fraudulent until sometime after the transaction is complete and fully processed. The requirements to finalize a transaction will vary depending on the transaction type and industry or business involved. For example, if the victim of the identity theft has to alert authorities or the subscriber before the theft is realized, it may take months before the subscriber knows that a transaction was fraudulent. There may also be some delay if the subscriber is unaware of the fraud until another party in the chain of the transaction notifies the subscriber. For instance, if the transaction involves a loan, the subscriber may not be notified of the fraud until the loan fails to go through and the loan provider contacts the subscriber.

If the transaction is legitimate and there was no fraud, then the process is finished at step 126. If the transaction is determined to be fraudulent despite the verification method employed, then the subscriber submits a claim under the warranty in step 120. The claim may be to reimburse the subscriber for the value of the transaction and any associated fees and other losses if the subscriber has already paid those expenses. Alternatively, the warranty may pay those expenses directly if they are still outstanding when the claim is submitted. The warranty reimburses the subscriber or pays the related expenses in step 122. The process is then completed at step 126.

In the car purchase example, if the purchaser successfully answers the verification questions correctly, even though that person is not the person represented in the identity information, the car dealer is still responsible for pay for the car, despite not having a legitimate purchaser to pay the dealer's cost for the car. In this situation, the warranty would be beneficial in covering the car dealer's liability, thereby preventing his loss of many thousands of dollars.

The warranty may provide protection to various parties involved in a transaction. While simple purchases typically involve two parties, more complicated transactions, such as the car purchase example or a real estate transaction, may involve several parties. These parties may include, but are not limited to, brokers, agents, loan officers, banks and financial institutions. Among these parties, the one in the transaction chain that may ultimately become liable for losses related to identity fraud may not be a party that had a direct relationship with the fraudster. Therefore, the warranty may be implemented in such as way as to protect parties with an indirect relationship to the fraudulent purchaser, as well as those who dealt directly with that person.

Financing for the warranty may be provided in a variety of ways. For instance, the warranty may be funded directly by the provider of the identity verification system, and the provider itself may pay out on the warranty when claims are submitted against it. Alternatively, the warranty may be insured to spread the risk of financial loss. This may be accomplished through a third party insurer, or the provider may self-insure alone or as part of a larger group of providers of similar services. Other methods and mechanisms for financing warranties are contemplated as within the scope of the present invention, and would be appreciated by those skilled in the art.

The warranty may also have limitations and exceptions which may help to keep the costs of maintaining the warranty down. For example, to help limit the total exposure of the service provider and/or the insurers, there may be caps on claims set at a predetermined amount. These caps may be set based upon the types of transactions involved. For instance, the cap on a car dealer warranty may be set at $50,000, while the cap on a clothing retailer credit transaction warranty may be set at $1000. There may be limits and exceptions based on other factors as well. For example, the warranty may reject a claim if an identity verification system was not used properly to verify the fraudulent party's identity. The warranty may also have a deductible, wherein the subscriber is reimbursed only for losses exceeding a preset amount or a percentage of the total loss. Such a deductible would encourage subscribers to only make claims where losses are significant, and would help lower the cost of the warranty to the subscriber. Other methods and mechanisms for limiting costs related to maintaining warranties are contemplated as within the scope of the present invention, and would be appreciated by those skilled in the art.

An alternative embodiment of the present invention is to provide the warranty on condition of the use of an identity verification system. Rather than offering the warranty as a feature of a particular identity verification system, a warranty may be offered to cover losses due to identity fraud with the condition that an identity verification system be used by the warranty subscriber. In this embodiment, the warranty provider may specify a particular identity verification system to be used in order to make claims against the warranty, or it may provide a list of acceptable systems. The warranty provider may also be the provider of the identity verification system. In this embodiment, all manner of limitations, exceptions, financing and insurance options as described above would also be applicable and are contemplated as being within the scope of the present disclosure.

While the present invention has been described in connection with an exemplary embodiment, it will be understood that many modifications will be readily apparent to those skilled in the art, and this application is intended to cover any adaptations or variations thereof. This invention should be limited only by the claims and equivalents thereof.

What is claimed:

1. A method for protecting a first party from loss in a transaction involving at least the first party and a second party, comprising:
verifying the second party's identity; and
providing a warranty to protect the first party in the event that the first party becomes liable for at least a portion of the transaction.

2. The method of claim 1, wherein the warranty also protects the first party in the event that the first party becomes liable for any related transaction fees.

3. The method of claim 1, wherein the warranty protects the first party in the event that a third party whose approval of the transaction is required rejects the transaction after determining that the second party's identity was fraudulently presented.

4. The method of claim 1, wherein verifying the second party's identity is performed prior to or at the time of sale.

5. The method of claim 1, wherein the first party is a party selling goods or services.

6. The method of claim 1, wherein the warranty is insured.

7. The method of claim 1, wherein the step of verifying the second party's identity further comprises:
obtaining identity information from the second party;
gathering background and historical information on the person described in the identity information;
generating at least one question based on the background and historical information gathered;
presenting the at least one question to the second party;
collecting the second party's response to the at least one question; and
determining the accuracy of the response, wherein if the response is accurate, the second party is presumed to be the same person as described in the identity information.

8. The method of claim 1, wherein the step of verifying the second party's identity further comprises:
obtaining identity information from the second party;
gathering biometric data from the second party;
comparing the gathered biometric data to known biometric data associated with the person described in the identity information; and
determining if the gathered biometric data matches the known biometric data, wherein if the gathered biometric data matches the known biometric data, the second party is presumed to be the same person as described in the identity information.

9. The method of claim 1, wherein the step of verifying the second party's identity further comprises:
obtaining identity information from the second party;
communicating a first code to a telephone associated with the identity information;
receiving a second code from the second party; and
determining if the second code corresponds to the first code, wherein if the second code corresponds to the first code, the second party is presumed to be the same person as described in the identity information.

10. The method of claim 9, wherein communicating a first code to a telephone associated with the identity information is accomplished through the use of one of a voice call, a text message, or an electronic mail message.

11. The method of claim 1, wherein the step of verifying the second party's identity further comprises:
obtaining identity information from the second party, wherein a first code is associated with the identity information;
communicating a request for a second code to a telephone associated with the identity information;
receiving the second code from the telephone associated with the identity information;
determining if the first code matches the second code, wherein if the first code matches the second code, the second party is presumed to be the same person as described in the identity information.

12. The method of claim 11, wherein a request for a second code to a telephone associated with the identity information is accomplished through the use of one of a voice call, a text message, or an electronic mail message.

13. A method for protecting a first party from loss in a transaction involving at least the first party and a second party, comprising:
providing a warranty to protect the first party in the event that the first party becomes liable for at least a portion of the transaction due to identity fraud on the part of the second party;
requiring, as a condition for coverage under the warranty, that the first party employ an identity verification system and verify the identity of the second party; and
reimbursing the first party costs associated with fraud losses in the event that the first party becomes liable for at least a portion of the transaction due to identity fraud on the part of the second party.

14. The method of claim 13, wherein the first party is a party selling goods or services.

15. The method of claim 13 wherein the step of verifying the second party's identity further comprises:
obtaining identity information from the second party;
gathering background and historical information on the person described in the identity information;
generating at least one question based on the background and historical information gathered;
presenting the at least one question to the second party;
collecting the second party's response to the at least one question; and
determining the accuracy of the response, wherein if the response is accurate, the second party is presumed to be the same person as described in the identity information.

16. The method of claim 13, wherein the step of verifying the second party's identity further comprises:
obtaining identity information from the second party;
gathering biometric data from the second party;
comparing the gathered biometric data to known biometric data associated with the person described in the identity information; and
determining if the gathered biometric data matches the known biometric data, wherein if the gathered biometric data matches the known biometric data, the second party is presumed to be the same person as described in the identity information.

17. The method of claim 13, wherein the step of verifying the second party's identity further comprises:
obtaining identity information from the second party;
communicating a first code to a telephone associated with the identity information;
receiving a second code from the second party; and
determining if the second code corresponds to the first code, wherein if the second code corresponds to the first code, the second party is presumed to be the same person as described in the identity information.

18. The method of claim 17, wherein communicating a first code to a telephone associated with the identity information is accomplished through the use of one of a voice call, a text message, or an electronic mail message.

19. The method of claim 13, wherein the step of verifying the second party's identity further comprises:
obtaining identity information from the second party, wherein a first code is associated with the identity information;
communicating a request for a second code to a telephone associated with the identity information;
receiving the second code from the telephone associated with the identity information;
determining if the first code matches the second code, wherein if the first code matches the second code, the second party is presumed to be the same person as described in the identity information.

20. The method of claim 19, wherein a request for a second code to a telephone associated with the identity information is accomplished through the use of one of a voice call, a text message, or an electronic mail message.
